(19) United States
(12) Patent Application Publication
(10) Pub. No.: US 2013/0256957 A1
(43) Pub. Date: Oct. 3, 2013

(54) TRANSLUCENT ALUMINA AND METHOD FOR PRODUCING TRANSLUCENT ALUMINA

(71) Applicant: SEIKO EPSON CORPORATION, Tokyo (JP)

(72) Inventors: Hideki ISHIGAMI, Hachinohe (JP); Hidefumi NAKAMURA, Hachinohe (JP); Junichi HAYASHI, Hachinohe (JP)

(73) Assignee: Seiko Epson Corporation, Tokyo (JP)

(21) Appl. No.: 13/850,363

(22) Filed: Mar. 26, 2013

(30) Foreign Application Priority Data
Mar. 27, 2012 (JP) 2012-072568

(51) Int. Cl. C01F 7/02

(52) U.S. Cl. CPC C01F 7/027; C01F 7/02
USPC 264/604; 423/625

(57) ABSTRACT

A translucent alumina has an alumina content of 99.98% by mass or more and a density of 3.97 g/cm³ or more, and in which the volume percentage of crystal textures having an aspect ratio of 1.5 or less and a long axis length of 10 μm or less is 93% or more.

### BACKGROUND

1. Technical Field

The present invention relates to a translucent alumina and a method for producing a translucent alumina.

2. Related Art

A translucent alumina (translucent aluminum oxide) sintered compact has been used in industry that takes advantage of specific properties of ceramics including excellent translucency, weather resistance, and hardness.

In general, the translucent alumina is produced in the following manner. First, an alumina powder, a sintering aid, and an organic binder are mixed to obtain a mixture. Thereafter, the mixture is molded by a press molding method, an injection molding method, or the like. Then, the resulting molded body is sintered in air, and thereafter further sintered in a normal pressure hydrogen atmosphere or in a vacuum, whereby a sintered compact is obtained (see, for example, JP-A-2000-219570).

The thus produced translucent alumina is composed of a polycrystalline alumina and therefore contains a substantial number of crystal grains.

However, the translucent alumina produced by such a method has a low light transmittance and therefore has limited applications. Further, the translucent alumina has a low gloss, and therefore the translucent alumina is aesthetically poor. In particular, when the translucent alumina is applied to an orthodontic member, if either the light transmittance or the gloss is low, the appearance is poor.

### SUMMARY

An advantage of some aspects of the invention is to provide a translucent alumina which has a high light transmittance and an excellent gloss and a method for producing a translucent alumina capable of efficiently producing such a translucent alumina.

An aspect of the invention is directed to a translucent alumina, wherein the translucent alumina has an alumina content of 99.98% by mass or more and a density of 3.97 g/cm³ or more, and the volume percentage of crystal textures having an aspect ratio of 1.5 or less and a long axis length of 10 μm or less is 93% or more.

According to this configuration, the crystal textures come in close contact with one another and also the shapes and particle diameters of the crystal textures are made uniform, and therefore, a translucent alumina which has a high light transmittance and an excellent gloss is obtained.

It is preferred that in the translucent alumina according to the aspect of the invention, the crystal textures have an average particle diameter of 2 μm or more and 9 μm or less.

According to this configuration, the crystal textures are more markedly densified and homogenized, and therefore, both the light transmittance and the gloss can be further enhanced.

It is preferred that Ar is contained in the translucent alumina according to the aspect of the invention.

According to this configuration, argon gas molecules prevent the migration of grain boundaries when sintering to prevent an increase in the size of the crystal textures or abnormal growth of the crystal textures. Accordingly, the crystal textures are densified and homogenized, and therefore, the resulting translucent alumina has a higher light transmittance and a higher gloss.

It is preferred that the content of Ar in the translucent alumina according to the aspect of the invention as measured by an inert gas melting method is 5 ppm or more.

According to this configuration, the formation of pores due to a too high an argon content can be prevented while reliably preventing the migration of grain boundaries. As a result, the optical property can be particularly enhanced.

It is preferred that in the translucent alumina according to the aspect of the invention, the translucent alumina has a total light transmittance in accordance with JIS K 7361-1 of 45% or more.

According to this configuration, a translucent alumina which is favorably used as an optical element or a variety of members utilizing the translucency is obtained.

It is preferred that in the translucent alumina according to the aspect of the invention, the translucent alumina has a glossiness in accordance with JIS Z 8741 of 4.0% or more.

According to this configuration, a translucent alumina which has a glossy surface and is aesthetically excellent is obtained.

It is preferred that in the translucent alumina according to the aspect of the invention, the translucent alumina has a three-point bending strength in accordance with JIS R 1601 of 450 MPa or more.

According to this configuration, a translucent alumina which has a sufficient mechanical property for use in a variety of applications is obtained.

Another aspect of the invention is directed to a method for producing a translucent alumina, including: molding a mixture of an alumina powder and an organic binder, thereby obtaining a molded body; subjecting the molded body to a debinding treatment, thereby obtaining a debinded body; sintering the debinded body in an argon atmosphere, thereby obtaining a sintered compact; and subjecting the sintered compact to a hot isostatic pressing treatment (an HIP treatment).

According to this configuration, a translucent alumina which has a high light transmittance and an excellent gloss can be efficiently obtained.

It is preferred that in the method for producing a translucent alumina according to the aspect of the invention, the sintering includes a first sintering treatment in which the debinded body is sintered in an air atmosphere and a second sintering treatment in which the debinded body after the first sintering treatment is sintered in an argon atmosphere at a higher temperature than the first sintering treatment.

According to this configuration, an increase in the size of the crystal textures or abnormal growth of the crystal textures can be prevented while preventing the deterioration of the alumina powder. As a result, the sintered compact can be densified and homogenized.

It is preferred that in the method for producing a translucent alumina according to the aspect of the invention, the HIP treatment is performed in an argon atmosphere.

According to this configuration, the translucent alumina can be further densified, and the optical property can be further enhanced.

### BRIEF DESCRIPTION OF THE DRAWINGS

The invention will be described with reference to the accompanying drawings, wherein like numbers reference like elements.

FIG. 1 is a perspective view showing a structure of an orthodontic bracket to which a translucent alumina according to an embodiment of the invention is applied.

FIG. 2 is a process chart showing a method for producing a translucent alumina according to an embodiment of the invention.

FIG. 3 is a schematic diagram showing a temperature profile in a sintering step.

### DESCRIPTION OF EXEMPLARY EMBODIMENTS

Hereinafter, a translucent alumina and a method for producing the same according to embodiments of the invention will be specifically described with reference to the accompanying drawings.

### Translucent Alumina

Translucent alumina is applied to a variety of products such as luminous tubes for discharge lamps, components (chambers, stages, support members, and window materials) for chemical processing devices, orthodontic members, artificial teeth, tableware, and jewelry goods.

Here, a translucent alumina in the related art has a problem that it has a low light transmittance and a low gloss, and therefore, the application thereof is limited and it is aesthetically poor, and there has been a strong demand for a translucent alumina which solves this problem.

In view of this, the present inventors made intensive studies to achieve a translucent alumina which has a high light transmittance and an excellent gloss. As a result, they found that the alumina content, the density, the aspect ratio of the crystal texture, and the long axis length of the crystal texture have a large effect on the optical property. Originally, these factors seemed not to have a causal relationship with the optical property of a sintered compact. However, the present inventors found that these factors interactively and synergistically act on the optical property of a sintered compact, and by carefully controlling these factors, the above problem can be solved.

That is, the translucent alumina according to an embodiment of the invention is configured such that the translucent alumina has an alumina content of 99.98% by mass or more and a density of 3.97 g/cm³ or more, and the volume percentage of crystal textures having an aspect ratio of 1.5 or less and a long axis length of 10 μm or less is 93% or more. Such a translucent alumina has a high light transmittance and also has a high gloss, which was originally thought to be contradictory to the light transmittance. Therefore, a translucent alumina which is aesthetically excellent is obtained. Further, the translucent alumina has an excellent optical property, and therefore can be used in many applications.

Hereinafter, the translucent alumina of the embodiment of the invention will be more specifically described.

The translucent alumina of the embodiment of the invention contains alumina in an amount of 99.98% by mass or more, which is high and therefore is substantially a sintered compact of alumina simple substance. Therefore, a sintering aid such as magnesium oxide or lanthanum oxide, which is contained in a translucent alumina in the related art, is not added except for the case where such a compound is unavoidably contained. Accordingly, it is considered that the property of the sintered compact is close to that of single crystal alumina (sapphire), and therefore the translucent alumina has a high light transmittance and an excellent gloss.

The translucent alumina of the embodiment of the invention is obtained by molding an alumina powder into a given shape, followed by debinding and sintering. The translucent alumina produced in this manner is composed mainly of a polycrystalline alumina. That is, the translucent alumina is composed of an assembly of alumina crystal textures.

This alumina contains α-alumina (a corundum type) or 7-alumina (a spinel type) as a main component, more preferably α-alumina as a main component. The α-alumina is chemically stable and has an excellent mechanical property, and therefore is useful as a main component of the translucent alumina.

The translucent alumina of the embodiment of the invention contains alumina in an amount of 99.98% by mass or more as described above, and preferably 99.99% by mass or more. It is considered that a sintered compact having such a purity substantially exhibits a property close to that of an alumina simple substance, and therefore has a low sintering property, but has a high optical property and a high mechanical property.

The alumina content can be measured by any of various compositional analyses such as inductively coupled plasma optical emission spectrometry (ICP), spark discharge optical emission spectrometry (OES), and X-ray fluorescent spectroscopy (XFS). Then, the amount of impurities (% by mass) is measured and subtracted from 100% by mass, and the resulting value can be used as the alumina content.

Further, the density of the translucent alumina of the embodiment of the invention is 3.97 g/cm³ or more as described above, and preferably 3.98 g/cm³ or more.

This density is preferably measured by the Measuring Methods for Specific Gravity of Solid specified in JIS Z 8807.

Further, the translucent alumina of the embodiment of the invention is configured such that the volume percentage of crystal textures having an aspect ratio of 1.5 or less and a long axis length of 10 μm or less is 93% or more as described above, and preferably 95% or more. Such a sintered compact has a high light transmittance and has a glossy surface. Further, such a sintered compact has an excellent three-point bending strength and therefore has a high mechanical property. The reason why such an effect is obtained has not been elucidated yet, but by decreasing the aspect ratio and also decreasing the length of the long axis, the cross-sectional shape of the crystal texture becomes smaller and closer to a perfect circle. Accordingly, the crystal textures come in closer contact with one another and also the shapes and particle diameters of the crystal textures are made uniform, and thus an environment is formed in which pores (air holes) are difficult to remain. As a result, factors causing the scattering of transmitted light are decreased, and therefore, the light transmittance is considered to be improved. In addition, since the crystal textures are densified and homogenized, the surface smoothness is improved, and therefore, the gloss is considered to be increased. In this manner, a high light transmittance and a high gloss, which are supposed to be originally contradictory to each other, can be achieved.

The aspect ratio and the long axis length can be determined by the magnifying observation of the cross-section of the translucent alumina and measuring the cross-section in the observed image. The magnifying observation may be performed using an electron microscope or a light microscope, and the long axis refers to the longest portion of the crystal texture in the observed image, and the short axis refers to the shortest portion in the perpendicular direction with respect to the long axis. Further, the aspect ratio is calculated as the ratio of (the length of the long axis)/(the length of the short axis).

The volume percentage of the crystal textures is obtained as an area ratio of the crystal textures in the observed image.

Further, the average particle diameter of the crystal textures is preferably 2 μm or more and 9 μm or less, and more preferably 3 μm or more and 8 μm or less. If the average particle diameter of the crystal textures is in the above-described range, the crystal textures are more markedly densified and homogenized, and therefore, both the light transmittance and the gloss can be further enhanced.

The average particle diameter is measured as a diameter (a projected area circle-corresponding diameter) of a perfect circle which has the same area as a projected area of a crystal texture in the observed image of the cross-section.

Here, the translucent alumina of the embodiment of the invention has a very high alumina content and contains substantially no components other than alumina. In general, a sintering aid is added to a translucent alumina in the related art, however, the translucent alumina of the embodiment of the invention contains substantially no sintering aid. Therefore, problems caused by the addition of a sintering aid are solved. One of the problems is an optical problem associated with the fact that a sintering aid is more likely to sublime. That is, it is considered that when a sintering aid sublimes, a void is formed in the place where the sintering aid was present, and this void causes light scattering. Accordingly, if a sintering aid is not contained, the light transmittance and the gloss can be further enhanced.

The phrase “contains substantially no sintering aid” refers to a state in which a sintering aid is not intentionally added. Therefore, a sintering aid component or any other elements unavoidably contained in an alumina starting material is permitted. The content of such components is, for example, 0.02% by mass or less.

On the other hand, the translucent alumina of the embodiment of the invention preferably contains argon internally. By incorporating argon therein, the translucent alumina has a higher light transmittance and a higher gloss. The reason why such an effect is obtained is that since the molecular size of argon is relatively large among gas molecules, the migration of grain boundaries is prevented when sintering and an increase in the size of the crystal textures or abnormal growth of the crystal textures is prevented. Accordingly, due to the presence of argon when crystals grow, the crystal textures are densified and homogenized. In addition, since argon is a rare gas and has low reactivity, even if argon is present in a sintered compact as described above, it hardly affects the property of alumina. Accordingly, the incorporation of argon is useful because argon prevents the migration of grain boundaries without adversely affecting the property of alumina.

The argon content in the translucent alumina is not particularly limited, however, the argon content as measured by an inert gas melting method is preferably 5 ppm or more in terms of mass ratio, more preferably 10 ppm or more and 1000 ppm or less, and even more preferably 15 ppm or more and 800 ppm or less. By setting the argon content in the above-described range, the formation of pores due to a too high argon content can be prevented while reliably preventing the migration of grain boundaries. As a result, the optical property can be particularly enhanced.

The inert gas melting method is a method for quantitatively analyzing argon released from the inside of a sample by heating and melting the sample at a high temperature in a crucible in an inert gas stream. In the case where the argon content is measured, as the inert gas, helium is preferably used. As an analyzer, for example, TC 436-AR manufactured by LECO Japan Corporation or the like may be used.

Further, the translucent alumina of the embodiment of the invention has a total light transmittance in accordance with JIS K 7361-1 of preferably 45% or more, and more preferably 50% or more. Such a sintered compact is preferably used as an optical element or a variety of members utilizing the translucency. For example, in the case where the translucent alumina is applied to an orthodontic member, when this orthodontic member is attached to teeth, the color of the teeth can be seen through the orthodontic member, and therefore, a good aesthetic property with a less unnatural look can be realized.

Further, the translucent alumina of the embodiment of the invention has a glossiness in accordance with JIS Z 8741 of preferably 4.0% or more, and more preferably 4.3% or more. Such a sintered compact has a glossy surface and therefore is aesthetically excellent. For example, in the case where the translucent alumina is applied to an orthodontic member, the texture of the orthodontic member is close to that of teeth, and therefore, when such an orthodontic member is attached to the teeth, the member has a less unnatural look.

Further, the translucent alumina of the embodiment of the invention has a three-point bending strength in accordance with JIS R 1601 of preferably 450 MPa or more, and more preferably 500 MPa or more. Such a sintered compact has a sufficient mechanical property for use in a variety of applications. Therefore, the sintered compact can be used in a condition such that impact or external stress is applied. For example, in the case where the translucent alumina is applied to an orthodontic member, a defect such as chipping or cracking is hardly caused, and therefore, a member which has high reliability can be obtained.

The translucent alumina of the embodiment of the invention has a high alumina content and also has a high density as described above, and therefore has a Mohs hardness of 8 or more, which is high. Accordingly, a translucent alumina having high abrasion resistance can be obtained.

Further, the translucent alumina of the embodiment of the invention has a fracture toughness in accordance with JIS R 1607 of preferably 3.5 MPa·m^{1/2} or more, and more preferably 4 MPa·m^{1/2} or more. Such a sintered compact has a sufficient mechanical property for use in a variety of applications. Therefore, the sintered compact can be used in a condition such that impact or external stress is applied.

### Orthodontic Member

Next, an application example of the translucent alumina of the embodiment of the invention will be described.

In the following description, an orthodontic bracket (orthodontic member) to which the translucent alumina of the embodiment of the invention is applied will be described.

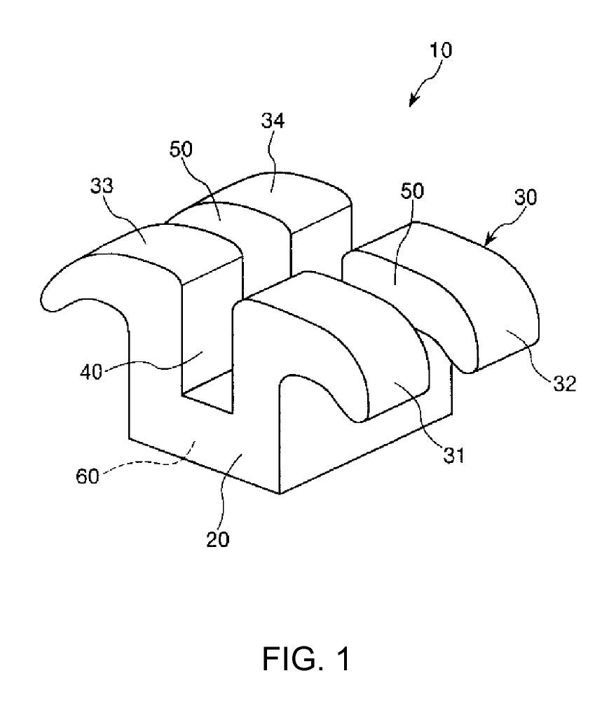

FIG. 1 is a perspective view showing a structure of an orthodontic bracket to which the translucent alumina of the embodiment of the invention is applied.

An orthodontic bracket (hereinafter also referred to in short as “bracket”) 10 shown in FIG. 1 is constituted by a plate-shaped base section (a bracket base or a bracket stem) 20 and an engaging section (tie wing) 30 formed in a manner protruding from the base section 20.

In the engaging section 30, a slot (groove) 40 through which a wire (not shown) is inserted is formed in a center portion.

Further, in the engaging section 30, another slot (groove) 50 intersecting with the slot 40 is formed. With these slots 40 and 50, the engaging section 30 is divided into two pairs of claw-shaped protruding sections 31, 32, 33, and 34, which extend outward.

In this embodiment, the shape of the cross-section of each of the slots 40 and 50 is a rectangle, but the shape is not limited thereto, and may be, for example, a V shape or a U shape.

Such a bracket 10 is used by fixing the bottom surface (back surface) 60 of the base section 20 to the teeth using an adhesive, a wire, or the like. In the case where the bracket 10 is attached to the front surface of the teeth, the color of the teeth is replaced by the color of the bracket 10. Therefore, the bracket 10 is preferably configured such that it does not deteriorate the impression of the look of the teeth and its presence is hardly noticeable. In view of this, the color of the bracket 10 is preferably almost transparent (translucent).

As described above, the translucent alumina of the embodiment of the invention has excellent translucency and also has an excellent mechanical property, and therefore is preferably applied to the bracket 10.

### Method for Producing Translucent Alumina

Next, the method for producing a translucent alumina of an embodiment of the invention will be described.

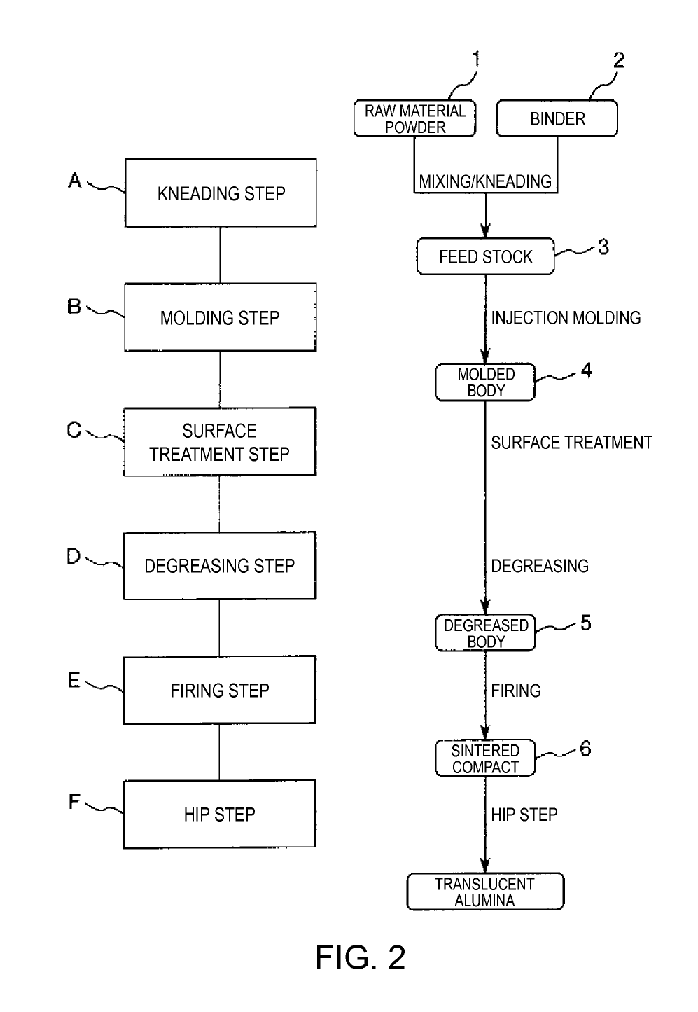

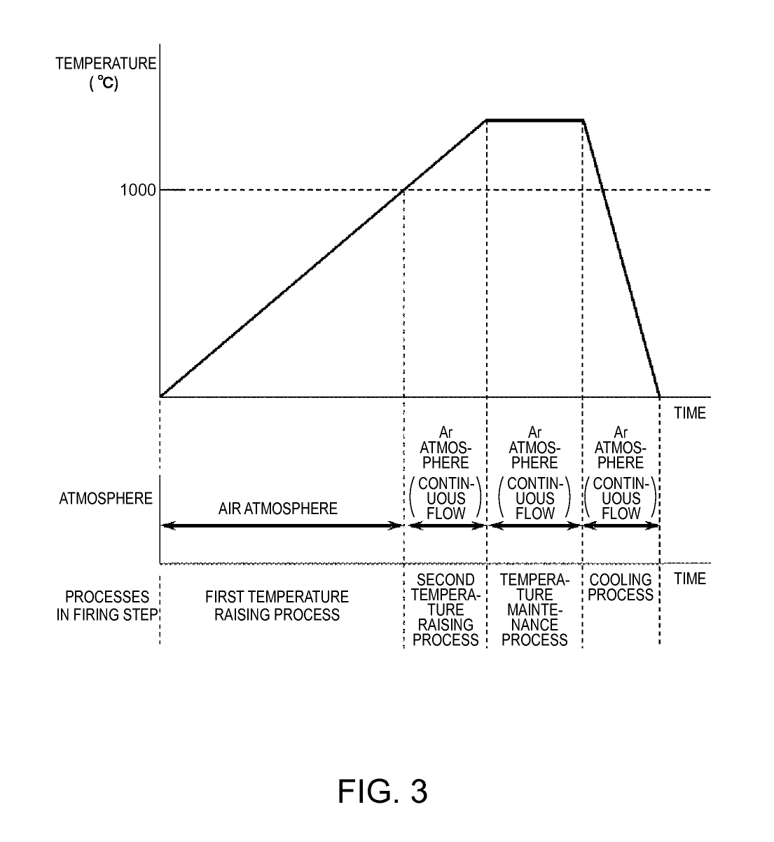

FIG. 2 is a process chart showing an embodiment of the method for producing a translucent alumina of the embodiment of the invention, and FIG. 3 is a schematic diagram showing a temperature profile in a sintering step.

The method for producing a translucent alumina shown in FIG. 2 includes: [A] a kneading step of kneading a composition to be used as a raw material; [B] a molding step of molding a feed stock obtained by the kneading; [C] a surface treatment step of subjecting the obtained molded body to a surface treatment; [D] a debinding step of debinding the obtained molded body; [E] a sintering step of sintering the obtained debinded body; and [F] an HIP step of subjecting the obtained sintered compact to an HIP treatment.

### [A] Kneading Step

[A-1] First, prior to the description of the kneading step, a composition to be used as a raw material of the translucent alumina will be described.

This composition contains a raw material powder 1 and an organic binder 2.

Hereinafter, the respective constituent components of the composition will be more specifically described.

### (a) Raw Material Powder

The raw material powder 1 is an alumina powder.

The average particle diameter of the raw material powder 1 has an effect on the size of the crystal textures which are formed when the raw material powder is formed into a sintered compact, and therefore is appropriately selected according to the size of the crystal textures desired to be formed. For example, the average particle diameter thereof is preferably about 0.05 μm or more and 5 μm or less, and more preferably about 0.1 μm or more and 3 μm or less. The average particle diameter of the raw material powder 1 refers to the particle diameter of a powder distributed at the point where the cumulative volume reaches 50% in a particle size distribution of the raw material powder 1.

Further, the BET specific surface area of the raw material powder 1 is preferably about 1 m²/g or more and 100 m²/g or less, and more preferably about 5 m²/g or more and 50 m²/g or less. By setting the BET specific surface area in the above-described range, the raw material powder 1 has a higher sintering property and contributes to the production of a sintered compact 6 which is dense and has few pores.

A feed stock 3 is formed by kneading the raw material powder 1 and the organic binder 2. The content of the raw material powder 1 in the feed stock 3 is preferably about 30% by volume or more and 70% by volume or less, and more preferably about 40% by volume or more and 60% by volume or less. By setting the content of the raw material powder 1 in the above-described range, the feed stock 3 has favorable fluidity. As a result, the filling property of the feed stock 3 in a molding die when molding is improved and a translucent alumina having a shape close to a final desired shape (near net shape) can be obtained.

### (b) Organic Binder

Examples of the organic binder 2 include polyethylene, polypropylene, an ethylene-vinyl acetate copolymer, polystyrene, polymethyl methacrylate, polybutyl methacrylate, polyamide, polyethylene terephthalate, polybutylene terephthalate, polyvinyl alcohol, a copolymer thereof, paraffin wax, microcrystalline wax, an oxidized wax, an ester wax, and low-molecular weight polyethylene, and these compounds can be used alone or by mixing two or more of them.

Among these compounds, it is preferred that a first component having a relatively high decomposition temperature and softening point and a second component having a relatively low decomposition temperature and softening point are mixed and used. By doing this, the fluidity of the organic binder 2 can be increased, and further, the moldability of a molded body 4 is enhanced and also the shape retainability thereof can be enhanced. As a result, a sintered compact 6 having high dimensional accuracy can be easily and reliably produced.

Among the above components, as a component corresponding to the first component, polyethylene, polypropylene, an ethylene-vinyl acetate copolymer, polystyrene, polymethyl methacrylate, polybutyl methacrylate, polyamide, polyethylene terephthalate, polybutylene terephthalate, polyvinyl alcohol, or a copolymer thereof can be used, and as a component corresponding to the second component, paraffin wax, microcrystalline wax, oxidized wax, ester wax, or low-molecular weight polyethylene can be used.

Among these, as the first component, at least one of polystyrene and an ethylene-vinyl acetate copolymer is preferably used, and as the second component, paraffin wax is preferably used.

Further, the content of the second component in the organic binder 2 is preferably about 10% by mass or more and 40% by mass or less, and more preferably about 15% by mass or more and 35% by mass or less. By setting the content of the second component in the above-described range, the viscosity of the feed stock 3 during kneading can be optimized, and also the dispersibility and fluidity of the raw material powder 1 and the organic binder 2 can be highly enhanced. As a result, the raw material powder 1 and the organic binder 2 are uniformly dispersed, and a molded body 4 to which the shape of the cavity of a molding die has been faithfully transferred can be obtained.

The composition as described above may further contain an additive in addition to the (a) raw material powder 1 and the (b) organic binder 2.

Examples of such an additive include a dispersant (lubricant) and a plasticizer, and these additives can be used alone or in combination of two or more of them.

Examples of the dispersant include higher fatty acids such as stearic acid, distearic acid, tristearic acid, linolenic acid, octanoic acid, oleic acid, palmitic acid, and naphthenic acid; anionic organic dispersants such as polyacrylic acid, polymethacrylic acid, polymaleic acid, an acrylic acid-maleic acid copolymer, and polystyrene sulfonic acid; cationic organic dispersants such as a quaternary ammonium salt; nonionic organic dispersants such as carboxymethyl cellulose and polyethylene glycol; and inorganic dispersants such as tricalcium phosphate.

Examples of the plasticizer include phthalate esters (e.g., DOP, DEP, and DBP), adipic acid esters, trimellitic acid esters, and sebacic acid esters.

[A-2] Subsequently, the above-described constituent components are mixed and kneaded. By doing this, the feedstock 3 is obtained.

[A-2a] First, the mixture of the composition is preheated at a given temperature. This preheating may be performed as desired and can be omitted.

The temperature of this preheating is preferably in the range of T₁ [° C.] or higher and T₁+100 [° C.] or lower in the case where the softening point of the first component in the organic binder 2 is represented by T₁ [° C.], and the softening point of the second component therein is represented by T₂ [° C.]. The first component and the second component are usually mixed in the form of a powder, but are softened through the preheating in the above-described temperature range. Accordingly, the first component and the second component easily penetrate into voids between particles of the raw material powder 1, whereby voids can be prevented from remaining in the feed stock 3. As a result, a sintered compact 6 having a high density can be obtained eventually. Further, by preheating in the above-described temperature range, the affinity of the first component and the second component for the raw material powder 1 is increased. Due to this, after the preheating, the mutual dispersibility of the respective components in the subsequent kneading step can be further increased.

If the preheating temperature is lower than the above-described lower limit, the first component cannot be softened by the preheating, and therefore, the above-described effects and advantages may not be obtained. On the other hand, if the preheating temperature is higher than the above-described upper limit, the second component begins to be decomposed and the property of the organic binder 2 may be deteriorated.

Further, the preheating temperature range is preferably T₁ [° C.] or higher and T₁+50 [° C.] or lower.

Further, the preheating time is preferably about 5 minutes or more and 60 minutes or less.

[A-2b] Subsequently, the preheated mixture is kneaded.

The kneading temperature is preferably T₂ [° C.] or higher and lower than T₁ [° C.]. By performing the kneading at a temperature in the above-described range, the first component is almost not melted or softened and only the second component is melted or softened in the mixture. Therefore, the fluidity of the feed stock 3 is improved and in the subsequent molding step, the feed stock 3 can be filled in every corner of the cavity of the molding die. As a result, the shape transferability when molding can be further enhanced.

Further, if the kneading temperature is in the above temperature range, the first component is in a solid state without melting or softening. Therefore, the fluidity of the feed stock 3 can be prevented from increasing too high. In other words, by incorporating the first component in a solid state, it can be ensured that the feed stock 3 has a certain degree of viscosity. It becomes possible to apply a larger shearing force to such a feed stock 3 during kneading. Accordingly, the mutual dispersibility of the raw material powder 1 and the organic binder 2 is increased, and thus the feed stock 3 becomes more homogeneous. In addition, the mutual dispersibility of the alumina powder in the raw material powder 1 is also increased and can be distributed evenly. As a result, uneven debinding in the below-described debinding step or uneven sintering in the below-described sintering step can be prevented from occurring, and eventually, a sintered compact 6 having a high density and high translucency can be obtained.

If the kneading temperature is lower than the above-described lower limit, the second component cannot be softened, and therefore, the fluidity is not imparted to the feed stock 3, and therefore, it may not be possible to knead the mixture. On the other hand, if the kneading temperature is higher than the above-described upper limit, not only the second component, but also the first component is softened, and therefore, the viscosity of the entire organic binder 2 may be significantly decreased. In this state, even if one attempts to knead the mixture, a sufficient shearing force cannot be applied to the feedstock 3 (a stirring force cannot be sufficiently transferred to the feed stock 3), and therefore, kneading is insufficient. As a result, an alumina powder cannot be sufficiently dispersed, resulting in an increase in the size of the crystal grains partially.

Further, the kneading time is preferably about 15 minutes or more and 210 minutes or less.

The kneading step may be performed in any atmosphere in the same manner as the mixing step. However, it is preferred that the kneading is performed in a vacuum or in a reduced pressure (e.g., at 3 kPa or less) or in a non-oxidative atmosphere, for example, in an atmosphere of an inert gas such as nitrogen gas, argon gas, or helium gas.

The mixture can be kneaded using any of various kneading machines such as a pressure or double-arm kneader-type kneading machine, a roll-type kneading machine, a Banbury-type kneading machine, and a single-screw or twin-screw extruding machine, however, particularly, it is preferred to use a pressure kneader-type kneading machine. Since the pressure kneader-type kneading machine can apply a large shearing force to the mixture, kneading can be performed reliably even if the viscosity of the mixture is high.

Further, it is preferred that the inner surface of a kneading vessel and the surface of a kneading screw of the kneading machine are coated with a ceramic. By doing this, the contamination of the feed stock with metal impurities can be prevented. Further, the coating is more preferably a coating of alumina.

Further, it is preferred that after completion of the preheating in the step [A-2a], the kneading of the mixture in the present step [A-2b] is performed successively (continuously) to the preheating without cooling the mixture to a temperature lower than the softening point T₂ [° C.] of the second component. By doing this, the occurrence of problems caused by cooling such as the formation of voids due to shrinkage of the preheated organic binder 2 by cooling can be prevented.

The thus obtained feed stock 3 is pulverized into pellets (small particles) as needed. The particle diameters of the pellets are set to, for example, about 1 mm or more and 10 mm or less.

In the pelletization of the feedstock 3, a pulverizing device such as a pelletizer can be used.

### [B] Molding Step

Subsequently, the feed stock 3 is molded by any of various molding methods. Examples of the molding method include an injection molding method, a press molding method, and an extrusion molding method, however, in the following description, a case where molding is performed using an injection molding method is described.

In the injection molding method, the feed stock 3 is molded by an injection molding machine, and a molded body 4 having a desired shape and dimension is formed. At this time, by selecting a cavity of a molding die, a molded body 4 having a complicated and fine shape can be easily formed. That is, by using an injection molding method, it is possible to mold a shape close to a desired shape (a near net shape). Therefore, it is possible to omit post-processing or to reduce the amount of processing to a great extent, and as a result, the production process can be simplified. In particular, since alumina which has an extremely high hardness and therefore is difficult to be processed is used as a raw material in the embodiment of the invention, the point that the post-processing can be omitted or reduced is effective.

The condition for the injection molding varies depending on the composition or the particle diameter of the raw material powder 1 to be used, the composition of the organic binder 2 to be used, the blending amount of these components, and the like, however, for example, a material temperature is preferably set to about 80° C. or higher and 200° C. or lower, and an injection pressure is preferably set to about 2 MPa or more and 15 MPa or less (20 kgf/cm² or more and 150 kgf/cm² or less).

The shape and dimension of the molded body 4 to be formed are determined in anticipation of the amount of shrinkage of the molded body 4 by the debinding step and the sintering step to be performed thereafter.

### [C] Surface Treatment Step

Impurities adhered to the inner surface of the cavity are transferred to the surface of the molded body 4 formed by the injection molding method. These impurities are adhered to the surface of a sintered compact obtained by debinding and sintering the molded body, and therefore, light is inhibited from entering into the sintered compact and therefore have an adverse effect on the translucency of the sintered compact in the related art.

In view of this, resin particles may be injected onto the surface of the molded body 4 as needed. The injected resin particles collide with the surface of the molded body 4 to apply collision energy thereto. By doing this, a surface treatment can be performed to grind and remove the impurities present on the surface of the molded body 4. As a result, the impurities can be prevented from remaining on the surface of a finally obtained sintered compact.

Further, by injecting resin particles, burrs generated in the molded body 4 can also be removed.

By using the resin particles as particles to be injected onto the surface of the molded body 4, the collision energy to be applied to the molded body 4 can be optimized. That is, since the resin particles have a relatively light weight and also have a relatively low hardness, the application of excessive collision energy to the molded body 4 is prevented. By doing this, only the outermost surface layer of the molded body 4 can be ground without adversely affecting the shape and dimension of the molded body 4 or the surface smoothness thereof. As a result, a sintered compact 6 having high translucency can be obtained and also a significant decrease in the dimensional accuracy of the sintered compact 6 by the surface treatment step can be prevented.

A constituent material of the resin particles to be used in this step is preferably a material which is decomposed and removed in the below-described debinding step. Even if such resin particles are adhered to the surface of the molded body 4 when being injected onto the surface of the molded body 4, the resin particles are decomposed and removed in the below-described debinding step. Therefore, it is possible to prevent the component derived from the resin particles from remaining on the sintered compact 6 and to prevent the translucency of the sintered compact 6 from deteriorating.

In view of this, examples of the constituent material of the resin particles include polyethylene, polypropylene, polyamide (nylon), an acrylic resin, polyester, and polystyrene, and these compounds can be used alone or in combination of two or more of them.

Among these, resin particles containing polyamide as a main material are preferred. Since such resin particles have an optimal hardness with respect to the hardness of the surface of the molded body 4, only the outermost surface layer of the molded body 4 can be particularly reliably ground. Further, even if such resin particles injected onto the molded body 4 are adhered to the surface thereof, polyamide is easily decomposed and removed in the below-described debinding step. Therefore, it is possible to reliably prevent the resin particles from remaining on the sintered compact 6.

The average particle diameter of the resin particles is preferably about 10 μm or more and 200 μm or less, and more preferably about 50 μm or more and 150 μm or less. If the average particle diameter of the resin particles is in the above-described range, the impurities adhered to the surface of the molded body 4 can be reliably removed while preventing the formation of a significantly large grinding mark on the surface of the molded body 4 by the collision of the resin particle. In this manner, significant irregularities or impurities can be prevented from remaining on the surface of the sintered compact 6 and the sintered compact 6 having excellent translucency can be produced. Further, if the average particle diameter of the resin particles is in the above-described range, the mass of the resin particles, that is, the collision energy to be applied to the molded body 4 can be optimized, and therefore, a significant decrease in the dimensional accuracy of the molded body 4 can be prevented.

### [D] Debinding Step

Subsequently, the surface-treated molded body 4 is subjected to a debinding treatment. By doing this, the organic binder 2 in the molded body 4 is decomposed and removed, whereby a debinded body 5 is obtained.

In the debinding step, the molded body 4 is gradually heated, and at this time, the organic binder 2 in the molded body 4 is decomposed.

Here, in the case where the organic binder 2 contains the first component and the second component having a decomposition temperature lower than the first component as described above, in the temperature raising process, first, the second component is decomposed and removed, and thereafter, the first component is decomposed and removed. By decomposing and removing the first component and the second component at different times, the organic binder 2 is prevented from explosively decomposing and evaporating, and also by decomposing the first component after decomposing the second component, a decrease in the shape retainability of the molded body 4 during the debinding step can be prevented. In this manner, the molded body 4 can be reliably debinded while preventing the occurrence of cracking, and eventually, a sintered compact 6 having high dimensional accuracy can be obtained.

Further, by decomposing and removing the second component first, a small flow path is formed in a track through which a volatile substance of the second component passes. This flow path can be used for efficiently and reliably discharging the first component to the outside by allowing a volatile substance of the first component to pass through the flow path. In this manner, the organic binder 2 containing the first component and the second component are reliably removed.

This flow path is gradually closed from a central portion thereof as the sintering of the debinded body 5 progresses in the below-described sintering step. In this manner, it is possible to reliably prevent the organic binder 2 and pores from remaining in the finally obtained sintered compact 6.

The heating temperature (debinding temperature) of the molded body 4 in the debinding treatment is preferably about 400° C. or higher and 600° C. or lower, and more preferably about 450° C. or higher and 550° C. or lower. By setting the debinding temperature in the above-described range, the organic binder 2 having a general composition can be reliably removed. Further, the rapid debinding of the molded body 4 is prevented, and therefore the occurrence of cracking in the molded body 4 or a significant decrease in the dimensional accuracy thereof can be prevented.

Further, the heating time (debinding time) can be appropriately set according to the debinding temperature, but is preferably about 0.5 hours or more and 30 hours or less, and more preferably about 1 hour or more and 20 hours or less.

Further, an atmosphere in which the debinding treatment is performed is preferably an air atmosphere, a vacuum (or a reduced pressure) atmosphere, or an atmosphere of an inert gas such as nitrogen gas or argon gas. By doing this, it is possible to prevent the deterioration of the raw material powder 1 in the molded body 4.

The debinding treatment may be performed in a plurality of divided steps for various purposes (for example, for the purpose of reducing the debinding time, improving the shape retainability, etc.). In this case, the debinding treatment may be performed, for example, in such a manner that debinding is performed at a low temperature in the former half and at a high temperature in the latter half or in such a manner that debinding at a low temperature and debinding at a high temperature are alternately repeated.

Further, the organic binder 2 may partially remain in the debinded body 5. The remaining organic binder 2 can enhance the shape retainability of the debinded body 5 and can be removed in the below-described sintering step.

### [E] Sintering Step

Subsequently, the debinded body 5 is sintered. By doing this, the debinded body 5 is sintered, whereby a sintered body 6 is obtained. That is, a bracket 10 is obtained.

The heating temperature (peak sintering temperature) of the debinded body 5 is preferably about 1100° C. or higher and 1900° C. or lower, and more preferably about 1200° C. or higher and 1800° C. or lower. By setting the sintering temperature in the above-described range, it becomes possible to reliably sinter the debinded body 5 while preventing a significant increase in the size of crystal grains.

Here, in a process of raising the temperature from room temperature to the above-described heating temperature, the temperature may be raised while maintaining the sintering condition constant, but it is preferred that the temperature is raised in two divided steps by changing the sintering condition in the course of the temperature raising process. Hereinafter, the temperature raising process will be described by referring to the former half of the temperature raising process as a first temperature raising process and the latter half thereof as a second temperature raising process. The number of times the temperature raising process is divided is not particularly limited, and the process may be divided into three or more.

### [E-1] First Temperature Raising Process

The first temperature raising process according to this embodiment is a process of raising the temperature from room temperature to 1000° C. as shown in FIG. 3.

In the first temperature raising process, it is preferred to set a temperature raising rate to about 10° C./h or more and 400° C./h or less. By setting the temperature raising rate in the above-described range, the debinded body 5 can be sintered while optimizing the migration of grain boundaries.

The atmosphere in the first temperature raising process is not particularly limited and may be an inert gas atmosphere such as a nitrogen atmosphere or an argon atmosphere, a reducing atmosphere such as a hydrogen atmosphere, or the like, however, as shown in FIG. 3, an oxidative atmosphere such as an oxygen atmosphere or an air atmosphere is preferred, and from the viewpoint of cost and the like, an air atmosphere is more preferred. By setting the atmosphere in this manner, in the first temperature raising process, the organic binder 2 remaining in the debinded body 5 can be efficiently and reliably removed and the debinded body 5 can be favorably sintered in the below-described second temperature raising process. As a result, components (such as carbon) derived from the organic binder 2 in the sintered compact 6 can be prevented from remaining.

The first temperature raising process is preferably performed while allowing oxygen gas or air to flow continuously. By doing this, debinding can be more reliably achieved. The flowing amount of the gas at this time is appropriately set according to the size of a sintering furnace, but is, for example, preferably about 1 L/min or more and 20 L/min or less, and more preferably about 3 L/min or more and 10 L/min or less.

Further, the temperature at the turning point from the first temperature raising process to the second temperature raising process need not be 1000° C. and can be appropriately set in a range of, for example, 500° C. or higher and 1200° C. or lower.

### [E-2] Second Temperature Raising Process

The second temperature raising process according to this embodiment is a temperature raising process performed at a higher temperature than the first temperature raising process and is a temperature raising process in which the temperature is raised from 1000° C. to the above-described heating temperature as shown in FIG. 3.

In the second temperature raising process, it is preferred to set a temperature raising rate to about 10° C./h or more and 400° C./h or less. By setting the temperature raising rate in the above-described range, the debinded body 5 can be sintered while optimizing the migration of grain boundaries.

As the atmosphere in the second temperature raising process, as shown in FIG. 3, an argon atmosphere is preferably employed. By setting the atmosphere in this manner, an increase in the size of the crystal textures or abnormal growth of the crystal textures can be prevented while preventing the deterioration or the like of the raw material powder 1. This is because, as described above, argon gas is an inert gas and the molecular size of argon is relatively large among gas molecules, and therefore, argon functions to prevent the migration of grain boundaries. Accordingly, by the second temperature raising process in an argon atmosphere, the crystal textures of the sintered compact 6 can be densified and homogenized.

By performing the second temperature raising process in an argon atmosphere in this manner, argon remains in the sintered compact 6. The residual amount (content) of argon varies depending on the frequency of contact between the sintered compact 6 and argon gas in this sintering step. Therefore, the residual amount of argon can be increased by prolonging the sintering step in an argon atmosphere, increasing the concentration of argon, or allowing argon gas to flow continuously.

In the case where the organic binder 2 remains in the debinded body 5 to be subjected to the second temperature raising process, although it is difficult for the debinding of the organic binder 2 to advance in an argon atmosphere, by performing the above-described first temperature raising process in an oxidative atmosphere, it is possible to reliably allow argon gas to function in the second temperature raising process.

The concentration of argon gas in the argon atmosphere is not particularly limited, but is preferably 50% by volume or more, and more preferably 70% by volume or more. By setting the concentration of argon gas in the above-described range, it is possible to reliably allow argon gas to function. In the atmosphere, an inert gas such as nitrogen gas or helium gas or a reducing gas such as hydrogen gas may be contained other than argon gas.

Further, the second temperature raising process is preferably performed while allowing argon gas to flow continuously as described above. By doing this, debinding can be more reliably achieved and argon can also be reliably allowed to remain inside the sintered compact. The flowing amount of argon at this time is appropriately set according to the size of a sintering furnace, but is, for example, preferably about 1 L/min or more and 20 L/min or less, and more preferably about 3 L/min or more and 10 L/min or less.

### [E-3] Temperature Maintenance Process

In the second temperature raising process, after reaching the above-described heating temperature, the temperature is maintained at the heating temperature for a given period of time. By doing this, the sintering of the debinded body 5 is completed. The time of maintaining the temperature is preferably 0.5 hours or more and 10 hours or less, and more preferably 1 hour or more and 7 hours or less. It is preferred that during this period of time, argon gas is allowed to flow continuously as shown in FIG. 3.

### [E-4] Cooling Process

After maintaining the temperature at the heating temperature for a given period of time, the sintered compact 6 is cooled in an inert gas atmosphere such as a nitrogen atmosphere or an argon atmosphere, a reducing atmosphere such as a hydrogen atmosphere, or an air atmosphere.

Preferably, the cooling is performed in an argon atmosphere. By doing this, argon gas penetrating into the sintered compact 6 can be prevented from releasing during cooling. It is also preferred that during this period of time, argon gas is allowed to flow continuously as shown in FIG. 3.

### [F] HIP Step

Subsequently, the sintered compact 6 is subjected to an HIP treatment (hot isostatic pressing treatment). By doing this, the sintered compact 6 is further densified, and the optical property thereof can be further enhanced. The HIP treatment may be performed as needed.

The condition for the HIP treatment is set, for example, as follows: the temperature is 1000° C. or higher and 2000° C. or lower, and the time is 1 hour or more and 10 hours or less.

Further, a pressure to be applied is preferably 50 MPa or more, and more preferably 100 MPa or more and 300 MPa or less.

The atmosphere in the HIP treatment is not particularly limited, but is preferably an argon atmosphere. By performing the HIP treatment in an argon atmosphere, argon gas molecules penetrate into the sintered compact 6 to prevent an increase in the size of the crystal textures or abnormal growth of the crystal textures during the HIP treatment. As a result, the crystal textures of the sintered compact 6 can be further densified and homogenized.

The concentration of argon gas in the argon atmosphere is not particularly limited, but is preferably 50% by volume or more, and more preferably 70% by volume or more. By setting the concentration of argon gas in the above-described range, it is possible to reliably allow argon gas to function. In the atmosphere, an inert gas such as nitrogen gas or helium gas or a reducing gas such as hydrogen gas may be contained other than argon gas.

The translucent alumina of the embodiment of the invention can be obtained as described above. The term “translucent alumina” as used herein includes a sintered compact obtained after the above-described sintering step and the HIP product obtained after the HIP step.

Hereinabove, the translucent alumina and the method for producing a translucent alumina of the invention is described based on preferred embodiments, however, the invention is not limited thereto.

For example, an arbitrary step can be added as desired to the method for producing a translucent alumina of the invention. For example, the molded body, the debinded body, or the sintered compact may be subjected to mechanical processing. In this case, the molded body and the debinded body have a lower hardness than the sintered compact, and therefore can be easily subjected to mechanical processing. Further, the debinded body has a lower shrinkage when sintering than the molded body, and therefore can be subjected to processing with high accuracy.

### EXAMPLES

### 1. Production of Translucent Alumina

### Example 1

<1> First, as the raw material powder, an alumina (α-Al₂O₃) powder having an average particle diameter of 0.4 μm and a BET specific surface area of 7.5 m²/g was prepared.

<2> Subsequently, the following resin components were mixed in the following amounts, whereby an organic binder was prepared.

First Component
Polystyrene: 26% by mass (softening point: 120° C., decomposition temperature: 590° C.)
Ethylene-vinyl acetate copolymer: 30% by mass (softening point: 100° C., decomposition temperature: 475° C.)

Second Component
Paraffin wax: 28% by mass (softening point: 55° C., decomposition temperature: 248° C.)

Plasticizer
Dibutyl phthalate (DBP): 16% by mass

<3> Subsequently, the raw material powder and the organic binder were mixed at a volume ratio of 42:58, whereby a mixture was obtained.

Then, the obtained mixture was preheated at a temperature of 120° C. for 10 minutes.

Then, the preheated mixture was put into a pressure kneader-type kneading machine and kneaded at a temperature of 60° C. for 60 minutes, whereby a feed stock was obtained.

Then, the feed stock was pelletized by a pelletizer.

<4> Subsequently, the obtained feed stock was injection molded by an injection molding machine under the following molding condition, whereby a molded body was produced.

Molding Condition

Material temperature: 150° C.

Injection pressure: 11 MPa (110 kgf/cm²)

Shape: a disc shape (for the evaluation of optical property), a bar shape (for the evaluation of mechanical property)

<5> Subsequently, the molded body was debinded under the following debinding condition, whereby a debinded body was obtained.
Debinding Condition
Debinding temperature: 450° C.
Debinding time: 2 hours
Debinding atmosphere: air atmosphere

<6> Subsequently, the debinded body was sintered under the following sintering condition, whereby a sintered compact was obtained.

Sintering Condition
First Temperature Raising Process
Temperature raising range: from 25° C. to 1000° C.
Temperature raising rate: 200° C./hour
Atmosphere: air atmosphere
Second Temperature Raising Process
Temperature raising range: from 1000° C. to 1600° C.
Temperature raising rate: 200° C./hour
Atmosphere: argon atmosphere (argon concentration: 100% by volume, continuous flow)

After reaching 1600° C., the temperature was maintained for 3 hours. Thereafter, the sintered compact was cooled as follows.

Cooling Process
Temperature decreasing range: from 1600° C. to 25° C.
Temperature decreasing rate: 400° C./hour
Atmosphere: argon atmosphere (argon concentration: 100% by volume, continuous flow)

<7> Subsequently, the obtained sintered compact was subjected to an HIP treatment.

HIP Treatment Condition
Treatment temperature: 1600° C.
Treatment time: 3 hours
Atmosphere: argon atmosphere (argon concentration: 100% by volume)
Treatment pressure: 177.3 MPa (1750 atm.)

In this manner, a translucent alumina was obtained.

### Example 2

A translucent alumina was obtained in the same manner as in Example 1 except that the argon atmosphere in the second temperature raising process was changed to a mixed gas atmosphere in which the concentration of argon was 50% by volume and the concentration of nitrogen was 50% by volume (continuous flow).

### Example 3

A translucent alumina was obtained in the same manner as in Example 1 except that the temperature raising rates in the first and second temperature raising processes were changed to 100° C./hour, respectively.

### Example 4

A translucent alumina was obtained in the same manner as in Example 1 except that the atmospheres in the first temperature raising process, the second temperature raising process, and the HIP treatment were changed as shown in Table 1, respectively.

### Example 5

A translucent alumina was obtained in the same manner as in Example 1 except that the temperature raising process in the sintering step was performed such that the temperature was raised from 25° C. to 1600° C. in an argon atmosphere without dividing the temperature raising process into two.

### Comparative Example 1

<1> First, as the raw material powder, an alumina (α-Al₂O₃) powder having an average particle diameter of 0.4 μm and a BET specific surface area of 3.9 m²/g and magnesium oxide (MgO) powder were prepared.

<2> Subsequently, the following resin components were mixed in the following amounts, whereby an organic binder was prepared.

First Component
Polystyrene: 26% by mass (softening point: 120° C., decomposition temperature: 590° C.)
Ethylene-vinyl acetate copolymer: 30% by mass (softening point: 100° C., decomposition temperature: 475° C.)

Second Component
Paraffin wax: 28% by mass (softening point: 55° C., decomposition temperature: 248° C.)

Plasticizer
Dibutyl phthalate (DBP): 16% by mass

<3> Subsequently, the raw material powder and the organic binder were mixed at a volume ratio of 42:58, whereby a mixture was obtained.

Then, the obtained mixture was preheated at a temperature of 120° C. for 10 minutes.

Then, the preheated mixture was put into a pressure kneader-type kneading machine and kneaded at a temperature of 60° C. for 60 minutes, whereby a feed stock was obtained.

Then, the feed stock was pelletized by a pelletizer.

<4> Subsequently, the obtained feed stock was injection molded by an injection molding machine under the following molding condition, whereby a molded body was produced.

Molding Condition
Material temperature: 150° C.
Injection pressure: 11 MPa (110 kgf/cm²)
Shape: a disc shape (for the evaluation of optical property), a bar shape (for the evaluation of mechanical property)

<5> Subsequently, the molded body was debinded under the following debinding condition, whereby a debinded body was obtained.

Debinding Condition
Debinding temperature: 450° C.
Debinding time: 2 hours
Debinding atmosphere: air atmosphere

<6> Subsequently, the debinded body was sintered under the following sintering condition, whereby a sintered compact was obtained.

Sintering Condition
First Temperature Raising Process
Temperature raising range: from 25° C. to 1200° C.
Temperature raising rate: 200° C./hour
Atmosphere: hydrogen atmosphere (hydrogen concentration: 100% by volume, continuous flow)
Second Temperature Raising Process
Temperature raising range: from 1200° C. to 1700° C.
Temperature raising rate: 100° C./hour
Atmosphere: hydrogen atmosphere (hydrogen concentration: 100% by volume, continuous flow)

After reaching 1700° C., the temperature was maintained for 3 hours. Thereafter, the sintered compact was cooled as follows.

Cooling Process
Temperature decreasing range: from 1700° C. to 25° C.
Temperature decreasing rate: 400° C./hour
Atmosphere: hydrogen atmosphere (hydrogen concentration: 100% by volume, continuous flow)

<7> Subsequently, the obtained sintered compact was subjected to an HIP treatment.

HIP Treatment Condition
Treatment temperature: 1700° C.
Treatment time: 3 hours
Atmosphere: argon atmosphere (argon concentration: 100% by volume)
Treatment pressure: 177.3 MPa (1750 atm.)

In this manner, a translucent alumina was obtained.

### Comparative Example 2

A translucent alumina was obtained in the same manner as in Comparative Example 1 except that the temperature raising process in the sintering step was performed such that the temperature was raised from 25° C. to 1600° C. in an air atmosphere without dividing the temperature raising process into two. Further, the HIP treatment temperature was changed to 1600° C.

### Comparative Example 3

A translucent alumina was obtained in the same manner as in Comparative Example 2 except that the atmosphere in the sintering step was changed to a hydrogen atmosphere (hydrogen concentration: 100% by volume).

### Comparative Example 4

A translucent alumina was obtained in the same manner as in Comparative Example 2 except that the atmosphere in the sintering step was changed to a vacuum atmosphere (pressure: 3 Pa).

The production conditions for the translucent aluminas of the respective Examples and Comparative Examples are shown in Tables 1 and 2.

### 2. Evaluation of Translucent Alumina

### 2.1 Evaluation for Alumina Content

The translucent aluminas obtained in the respective Examples and Comparative Examples were evaluated for the alumina content by inductively coupled plasma optical emission spectrometry (ICP). The evaluation results are shown in Tables 1 and 2.

### 2.2 Evaluation for Density

The specific gravity (density) of each of the translucent aluminas obtained in the respective Examples and Comparative Examples was measured by the Measuring Methods for Specific Gravity of Solid specified in JIS Z 8807. Then, the relative density of the translucent alumina was calculated with respect to the true specific gravity of alumina of 3.99 g/cm³. The measurement results and the calculated results are shown in Tables 1 and 2.

### 2.3 Evaluation for Volume Percentage of Crystal Textures

The cross-section of each of the translucent aluminas obtained in the respective Examples and Comparative Examples was observed by a scanning electron microscope (at a magnification of 2000 times), and an observed image was obtained. Then, the observed image was subjected to image processing and the lengths of the long axes of arbitrarily extracted 100 crystal textures were measured and also aspect ratios were calculated.

Subsequently, the total sum of the areas of the 100 crystal textures and the sum of the areas of specific crystal textures having an aspect ratio of 1.5 or less and a long axis length of 10 μm or less were calculated, respectively. Then, the ratio of the sum of the areas of the specific crystal textures to the total sum of the areas (area ratio) was calculated, and the calculated value was used as the volume percentage of the specific crystal textures. The calculated results are shown in Tables 1 and 2.

### 2.4 Evaluation for Average Particle Diameter

With respect to each of the translucent aluminas obtained in the respective Examples and Comparative Examples, the observed image thereof was subjected to image processing, and the projected area circle-corresponding diameters of the above-described 100 crystal textures were calculated. The calculated results are shown in Tables 1 and 2.

### 2.5 Evaluation for Argon Content

With respect to each of the translucent aluminas obtained in the respective Examples and Comparative Examples, a content of argon contained therein was measured by an inert gas melting method. In this measurement, TC 436-AR, manufactured by LECO Japan Corporation was used as an analyzer. The measurement results are shown in Tables 1 and 2.

### 2.6 Evaluation for Total Light Transmittance

With respect to each of the translucent aluminas obtained in the respective Examples and Comparative Examples, a total light transmittance specified in JIS K 7361-1 was measured. In this measurement, a turbidity meter, NDH-2000, manufactured by Nippon Denshoku Industries Co., Ltd. was used. The measurement results are shown in Tables 1 and 2.

### 2.7 Evaluation for Glossiness

With respect to each of the translucent aluminas obtained in the respective Examples and Comparative Examples, a glossiness specified in JIS Z 8741 was measured. In this measurement, a gloss meter, PG-3D, manufactured by Nippon Denshoku Industries Co., Ltd. was used. The measurement results are shown in Tables 1 and 2.

### 2.8 Evaluation for Three-Point Bending Strength

With respect to each of the translucent aluminas obtained in the respective Examples and Comparative Examples, a three-point bending strength specified in JIS R 1601 was measured. In this measurement, a universal testing machine model 8852 (Load Cell 500N) manufactured by Instron Japan Company Limited was used. The measurement results are shown in Tables 1 and 2.

### 2.9 Evaluation for Fracture Toughness

With respect to each of the translucent aluminas obtained in the respective Examples and Comparative Examples, a fracture toughness specified in JIS R 1607 was measured by the IF method. In this measurement, a Vickers hardness testing machine, HV-115, manufactured by Mitutoyo Corporation and a micro hardness testing machine, HM-114, manufactured by Mitutoyo Corporation were used. The measurement results are shown in Tables 1 and 2.

TABLE 1

| | | | Unit | Example 1 | Example 2 | Example 3 | Example 4 | Example 5 |
|---|---|---|---|---|---|---|---|---|
| Sintering | First | Temperature raising | ° C. | 25 to 1000 | 25 to 1000 | 25 to 1000 | 25 to 1000 | 25 to 1600 |
| step | temperature | range | | | | | | |
| | raising | Temperature raising | ° C./h | 200 | 200 | 100 | 200 | 200 |
| | process | rate | | | | | | |
| | | Atmosphere | — | air | air | air | air | Ar (100%) |
| | Second | Temperature raising | ° C. | 1000 to 1600 | 1000 to 1600 | 1000 to 1600 | 1000 to 1600 | — |
| | temperature | range | | | | | | |
| | raising | Temperature raising | ° C./h | 200 | 200 | 100 | 200 | — |
| | process | rate | | | | | | |
| | | Atmosphere | — | Ar (100%) | Ar (50%) | Ar (100%) | Ar (50%) | — |
| | | | | | and N₂ | | and N₂ | |
| | | | | | (50%) | | (50%) | |
| | Cooling | Atmosphere | — | Ar (100%) | Ar (100%) | Ar (100%) | Ar (50%) | Ar (100%) |
| | process | | | | | | and N₂ | |
| | | | | | | | (50%) | |

| | | | | | | | |
|---|---|---|---|---|---|---|---|
| HIP step | Treatment temperature | ° C. | 1600 | 1600 | 1600 | 1600 | 1600 |
| | Atmosphere | — | Ar (100%) | Ar (100%) | Ar (100%) | N₂(100%) | Ar (100%) |
| Configuration of | Alumina content | mass % | 99.990 | 99.990 | 99.995 | 99.990 | 99.990 |
| sintered compact | Sintering aid | ppm | — | — | — | — | — |
| | Specific gravity | g/cm³ | 3.982 | 3.978 | 3.986 | 3.970 | 3.974 |
| | (density) | | | | | | |
| | Relative density | % | 99.8 | 99.7 | 99.9 | 99.5 | 99.6 |
| | Volume percentage | % | 95.3 | 95.1 | 96.2 | 93.6 | 94.8 |
| | Average particle | μm | 5.5 | 6.2 | 4.7 | 7.8 | 6.9 |
| | diameter | | | | | | |
| | Ar content | ppm | 20 | 15 | 40 | 5 | 10 |
| Evaluation results of | Total light | % | 55 | 51 | 61 | 48 | 47 |
| sintered compact | transmittance | | | | | | |
| | Glossiness | % | 8.1 | 6.2 | 8.3 | 4.9 | 4.6 |
| | Three-point bending | MPa | 552 | 495 | 571 | 475 | 487 |
| | strength | | | | | | |
| | Fracture toughness | MPa · m^{1/2} | 4.0 | 4.1 | 4.6 | 3.9 | 4.0 |

TABLE 2

| | | | | Comparative | Comparative | Comparative | Comparative |
|---|---|---|---|---|---|---|---|
| | | | Unit | Example 1 | Example 2 | Example 3 | Example 4 |
| Sintering | First | Temperature raising | ° C. | 25 to 1200 | 25 to 1600 | 25 to 1600 | 25 to 1600 |
| step | temperature | range | | | | | |
| | raising | Temperature raising | ° C./h | 200 | 200 | 200 | 200 |
| | process | rate | | | | | |
| | | Atmosphere | — | H₂ (100%) | air | H₂ (100%) | Vacuum (3 Pa) |
| | Second | Temperature raising | ° C. | 1200 to 1700 | — | — | — |
| | temperature | range | | | | | |
| | raising | Temperature raising | ° C./h | 100 | — | — | — |
| | process | rate | | | | | |
| | | Atmosphere | — | H₂ (100%) | — | — | — |
| | Cooling | Atmosphere | — | H₂ (100%) | air | H₂ (100%) | Vacuum (3 Pa) |
| | process | | | | | | |

| | | | | | | |
|---|---|---|---|---|---|---|
| HIP step | Treatment temperature | ° C. | 1700 | 1600 | 1600 | 1600 |
| | Atmosphere | — | Ar (100%) | Ar (100%) | Ar (100%) | Ar (100%) |
| Configuration of | Alumina content | mass % | 99.950 | 99.990 | 99.990 | 99.990 |
| sintered compact | Sintering aid | ppm | MgO 500 | — | — | — |
| | Specific gravity | g/cm³ | 3.986 | 3.982 | — | 3.958 |
| | (density) | | | | | |
| | Relative density | % | 99.9 | 99.8 | Not sintered | 99.2 |
| | Volume percentage | % | 100 | 92.0 | Not sintered | 90.1 |
| | Average particle | μm | 5.3 | 8.2 | Not sintered | 9.7 |
| | diameter | | | | | |
| | Ar content | ppm | 0 | 0 | Not sintered | 0 |
| Evaluation results of | Total light | % | 60 | 43 | — | 41 |
| sintered compact | transmittance | | | | | |
| | Glossiness | % | 3.9 | 8.7 | — | 3.6 |
| | Three-point bending | MPa | 580 | 560 | — | 310 |
| | strength | | | | | |
| | Fracture toughness | MPa · m^{1/2} | 4.0 | 4.5 | — | 2.8 |

As apparent from Tables 1 and 2, the translucent aluminas obtained in the respective Examples all had a high total light transmittance and a high glossiness, and were aesthetically excellent. Therefore, it can be said that such a translucent alumina is preferred as, for example, an orthodontic member with a less unnatural look.

Further, it was confirmed that by dividing the temperature raising process in the sintering step into two, both the total light transmittance and the glossiness can be further enhanced. In addition, it was also confirmed that by performing the first temperature raising process in an oxidative atmosphere and performing the HIP step in an argon atmosphere, the same enhancement could be obtained.

On the other hand, among the Comparative Examples, a translucent alumina obtained in Comparative Example 1 containing a sintering aid had a high total light transmittance, but had a low glossiness.

In Comparative Example 2, since the sintering step was performed in an air atmosphere, the volume percentage of the crystal textures having an aspect ratio of 1.5 or less and a long axis length of 10 μm or less did not fall within the predetermined range although the alumina content and the density fell within the predetermined ranges. As a result, it is considered that the translucent alumina obtained in Comparative Example 2 had a low total light transmittance, although it had a high glossiness.

In Comparative Example 3, the alumina powder could not be sufficiently sintered, and in Comparative Example 4, the density and the volume percentage were insufficient. As a result, it is considered that both the total light transmittance and the glossiness of the translucent alumina obtained in Comparative Example 4 were low.

From the above results, it was confirmed that according to the invention, a translucent alumina having a high total light transmittance and a high glossiness can be obtained.

The entire disclosure of Japanese Application No. 2012-072568 filed Mar. 27, 2012 is expressly incorporated by reference herein.

What is claimed is:

1. A translucent alumina comprising:
an alumina content of 99.98% by mass or more;
a density of 3.97 g/cm³ or more; and
a volume percentage of crystal textures having an aspect ratio of 1.5 or less and a long axis length of 10 μm or less of 93% or more.

2. The translucent alumina according to claim 1, wherein the crystal textures have an average particle diameter of 2 μm or more and 9 μm or less.

3. The translucent alumina according to claim 1, wherein the translucent alumina contains Ar.

4. The translucent alumina according to claim 3, wherein a content of Ar as measured by inert gas melting is 5 ppm or more.

5. The translucent alumina according to claim 1, wherein the translucent alumina has a total light transmittance in accordance with JIS K 7361-1 of 45% or more.

6. The translucent alumina according to claim 1, wherein the translucent alumina has a glossiness in accordance with JIS Z 8741 of 4.0% or more.

7. The translucent alumina according to claim 1, wherein the translucent alumina has a three-point bending strength in accordance with JIS R 1601 of 450 MPa or more.

8. A method for producing a translucent alumina, comprising:
molding a mixture of an alumina powder and an organic binder to obtain a molded body;
subjecting the molded body to a debinding treatment to obtain a debinded body;
sintering the debinded body in an argon atmosphere to obtain a sintered compact; and
subjecting the sintered compact to a hot isostatic pressing treatment.

9. The method for producing a translucent alumina according to claim 8, wherein the sintering further comprises a first sintering treatment in which the debinded body is sintered in an air atmosphere and a second sintering treatment in which the debinded body after the first sintering treatment is sintered in an argon atmosphere at a higher temperature than the first sintering treatment.

10. The method for producing a translucent alumina according to claim 8, wherein the hot isostatic pressing treatment is performed in an argon atmosphere.
